(19) United States
(12) Patent Application Publication
(10) Pub. No.: US 2006/0023902 A1
(43) Pub. Date: Feb. 2, 2006

(54) Compliant diaphragm for planar magnetic transducers

(76) Inventor: F. Bruce Thigpen, Tallahassee, FL (US)

Correspondence Address: Ralph A. Dowell of DOWELL & DOWELL P.C., 2111 Eisenhower Ave., Suite 406, Alexandria, VA, 22314, US

(21) Appl. No.: 10/522,874

(22) PCT Filed: Aug. 14, 2003
(86) PCT No.: PCT/US03/25475

§ 371 Date: Feb. 2, 2005

(30) Foreign Application Priority Data
Aug. 14, 2002 (US) 60402916

(51) Int. Cl. H04R 25/00

(52) U.S. Cl. 381/176; 381/191

(57) ABSTRACT

Planar magnetic transducers and acoustic speakers incorporating the transducers wherein improved frequency performance with lower distortion of acoustic diaphragms of the transducers is obtained by forming the diaphragms of film materials (20) which are significantly more compliant than materials used to form electrical circuit patterns (30) on the diaphragm film materials (20).

### CROSS REFERENCE TO RELATED APPLICATIONS

This application claims the benefit of U.S. Provisional Patent Application Ser. No. 60/402,916, filed Aug. 14, 2002, in the name of the same inventor.

### BACKGROUND OF THE INVENTION

1. Field of the Invention

The present invention is directed to the field of planar magnetic acoustic transducers and, more particularly, to the use of compliant films having metallic electrical trace patterns or circuits adhesively secured thereto to form sound producing diaphragms having improved low frequency responses and lower distortion levels and which are suitable for use in small panel type transducers.

2. Brief Description of the Related Art

Audio system markets desire small flat transducers with improved low frequency output, reduced distortion and enhanced efficiency. In a “Wireless World” article by Peter Walker, limitations are disclosed with respect to electrostatic loudspeakers, which limitations also apply to other types of tensioned film loudspeakers. The diaphragm mass limits high frequency performance, air load limits mid range performance and diaphragm stiffness limits low frequency performance. In an electrostatic loudspeaker, stiffness of the diaphragm is desirable because of the unstable situation that exists. When the polarizing voltage is high the diaphragm will be attracted to one stator. If the diaphragm compliance is high enough and a high polarizing voltage is used, a speaker diaphragm will fall in or collapse against one stator.

The foregoing is not a consideration in a planar magnetic or ribbon transducer because in an idle state of the transducer, there are no potential forces acting on the transducer diaphragm. However, the stiffness of the diaphragm is a greater factor because the diaphragm includes at least a conductor material. Favorable conductor materials include copper, aluminum and silver. In a planar magnetic speaker, the material of choice is a soft alloy aluminum. The conductor material is adhered or laminated to a film substrate, usually polyester. The sum of a compliance value of the conductor material and a compliance value of the film material define the overall diaphragm compliance. Also the layout of the conductor trace pattern and the ratio of conductor coverage to substrate film material affects the overall stiffness. The definition of compliance as described herein, is applied to the diaphragm material compliance and elasticity and not to the acoustic compliance. Compliance is thus a measure of elasticity or amount of elongation of a material where a strain of an elastic body is expressed as a function of a force producing the strain.

Historically, high compliance diaphragms have not been used in planar magnetic transducers due to several factors including limited available processes for laminating and etching circuits on suitable high compliance films, and limited focus on reducing transducer size by modifying the diaphragm. Most planar magnetic products were designed for home audio speakers and reduced area transducers were not a traditional design criteria. While there have been dual material diaphragms for fiat speakers incorporating a compliant surround around a driven area which responds like a rigid piston, typically an unsuitably high Q results at resonance and low frequency response is not improved significantly.

Resonance and modal patterns occur on the surface of a diaphragm that are usually much smaller than the wavelength of the sound being produced whereas, with high stiffness materials, the modal pattern amplitudes are increased. At some frequencies, modal patterns result in non linear motion of the diaphragm which causes distortion.

Low frequency limitations of a stretched membrane or diaphragm loudspeaker are further limited by tension. When the tension is reduced below a certain level, usually about one pound per square inch, loss of piston like motion occurs and non harmonic forms of distortion occur. This prevents small diaphragms from achieving low frequency capability because the necessarily high tension results in a high fundamental resonance. For example, with tension on the order of one pound per square inch, a rectangular diaphragm of approximately 5 by 7 inches will yield a resonance frequency of about 120 Hz and a diaphragm of approximately 7 by 20 inches yields a resonance frequency of about 60 Hz. The lower tension limit restricts the ability of the transducer to have significant output below these frequencies because of the high stiffness of the diaphragm.

An alternative approach of a multiple layer diaphragm increases the stiffness and mass thereby decreasing efficiency and low frequency output. Additional conductor layers increase energy potential but add mass and stiffness generally canceling the benefit of additional conductor length in a gap for a wide range transducer.

### SUMMARY OF THE INVENTION

It is an object of the invention to improve the low frequency response and distortion levels of a planar magnetic transducer by employing compliant films with the proposed techniques in the application. The resonance frequencies in the above speaker diaphragm examples can be reduced by at least a factor of two or more, using the diaphragm of the invention. With high compliance films, resonance frequencies of 30 Hz can be achieved on the small panel example (5″×7″) and 20 Hz or lower on the larger panel example (7″×20″). The reduced resonance represents significant improvement over known designs. Hence a transducer using the invented diaphragm, can operate at a much lower resonant frequency than a standard planar magnetic transducer of similar size and traditional diaphragm design. To state this another way, it is an object of the invention to reduce transducer size. A planar transducer using the diaphragm of the present invention can be much smaller in area than a traditional planar magnetic transducer diaphragm when the resonant frequencies of both are similar. This enables new applications and system designs using this type of planar magnetic transducer diaphragm.

In the present invention, a compliant material is used as a base film layer for a transducer diaphragm and to which is adhesively secured or laminated a metallic electrical circuit trace pattern. A ratio of a compliance value or ultimate elongation of the film material over a compliance value or ultimate elongation of the metallic conductor material must be substantially greater than one and preferable greater than approximately forty (40).

It is an object of this invention to reduce the size of planar electromagnetic transducers by improving low frequency performance and lowering distortion.

### BRIEF DESCRIPTION OF DRAWINGS

A better understanding of the invention will be had with reference to the accompanying Drawings wherein:

FIG. 1 shows a planar magnetic transducer with high compliance diaphragm;

FIG. 2 is a comparison of distortion performance for a) high compliance substrate of Urethane and b) standard Mylar® substrate showing reduced distortion; and

FIG. 3 single sided planar magnetic transducer with high compliance diaphragm.

### DESCRIPTION OF THE PREFERRED EMBODIMENT

Diaphragms designed for use with planar magnetic speakers typically are one thousands of an inch in thickness and include a laminated electrical circuit trace pattern which is designed to provide the electromechanical operation, as is commonly used in the art. The conductor trace layout and spacing is designed for locating in areas of maximum magnetic field strength provided by driving magnets as is well known in the art.

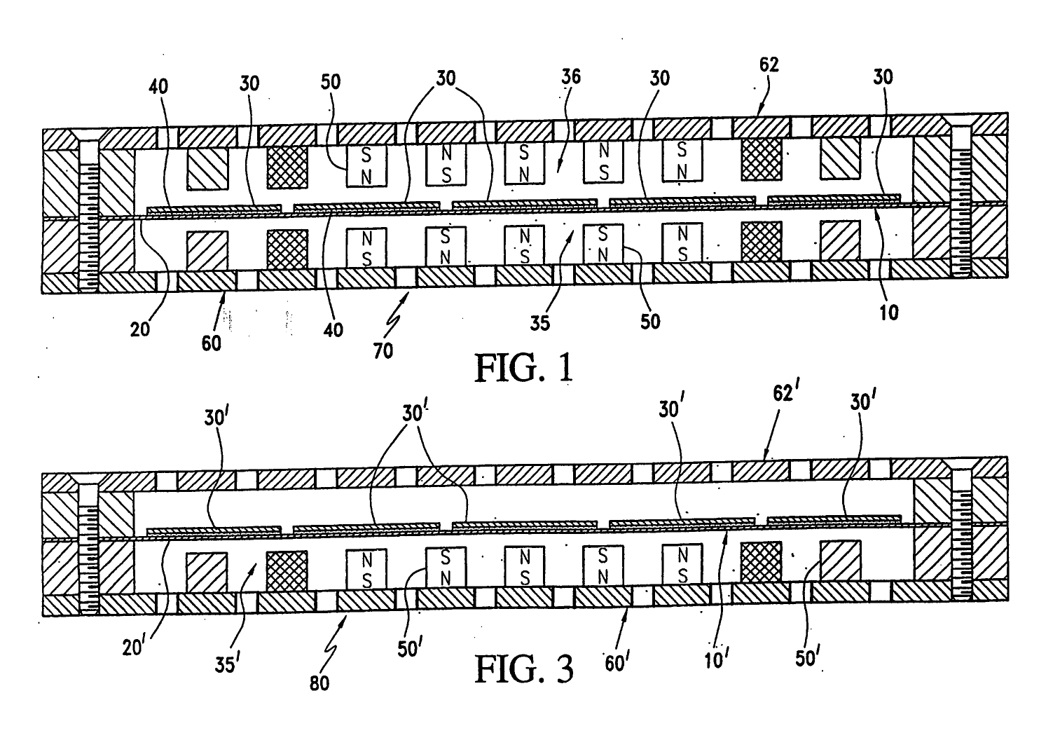

A preferred embodiment of high compliance diaphragm 10 for a planar magnetic transducer or speaker 70 is shown in FIG. 1 as being tensioned and located between opposing support frames 60 and 62 of the transducer stator. An open area of the diaphragm which is movable between the frames is known as the active surface area of the diaphragm. The diaphragm is mounted between opposing magnetic motors 35 and 36 each of which includes magnetic elements 50. As shown, the magnetic elements are preferably aligned with one another on opposite sides of the diaphragm with like poles opposing one another. The spacing or open area in the frames between of magnetic elements is provided for passage of sound waves created by vibration of the diaphragm when electrical energy is applied to a metallic conductor circuit pattern 30 which is applied to a surface of a high compliance substrate film 20. Examples of suitable film materials include Urethane, Tefzel® and Teflon® polymer thin films, however, non-polymer compliant thin films can also be used such as Nylon® or Lycra®, provided a suitable air seal is maintained and the conductor material suitably attached.

Ultimate elongation of typically used materials such as Mylar®, Kapton® or Kaledex® reduces the ability to have large diaphragm excursions because of limited ultimate elongation and compliance. Below resonance, the force required to stretch the material is greater than the force to move air within the transducer or the force available from the motor circuit reducing output. Additionally, as it is desirable for low frequency performance to have compliance in both axes in a plane of a diaphragm 10, the way to achieve this is through use of the substrate film 20 which has a significantly higher compliance or ultimate elongation than a metallic conductor material 30 applied to the film substrate.

The conductor traces 30 are shown attached to the high compliance diaphragm film 20 by a very thin adhesive layer 40. In a planar magnetic speaker, the material of choice for the conductor trace 30 is a soft alloy aluminum. Other conductor materials mentioned in the introduction can be similarly used in the invention. For many audio products, transducer dimensions are typically rectangular with aspect ratios on the order of 2:1 and higher. Because of the mechanical characteristic of a stretched film diaphragm, the width or narrow dimension of the transducer defines the resonance frequency.

Conductor runs are typically lengthwise on a transducer to minimize resistive losses from turns at the ends of the runs. As the transducer area is made smaller, the compliance of the conductor runs 30 becomes a dominant factor that is adjusted for by the high compliance substrate 20. The adhesive layer 40 is typically much thinner than the substrate film 10 or the conductor traces 30, hence its mechanical properties do not significantly effect the results and operation of the diaphragms of the invention.

Additionally, the diaphragm design can be applied independent of magnet motor structure, and can operate with conventional magnet configurations such as NSNS orientation or pole-piece motor structures. The diaphragms of the invention can also be applied independent of magnet material, and preferably are used with rare-earth permanent magnets such as Neodymium.

The high compliance material substrate 20 between the conductor trace runs increases the output of a flat panel stretched membrane loudspeaker by allowing a smaller percentage of the total force available to work against stretching the diaphragm 10 and a larger percentage of the force to move the surrounding air. The force is that created between the magnets on one or both sides of the diaphragm and the electrical field created when energy is applied to the conductor trace pattern. By using the techniques disclosed herein, significant increases in transducer output have been demonstrated. In combination, the conductor pattern, and the substrate compliance can allow the conductor to undergo large excursions and stay positioned within the best field portion of the motor magnetic circuit.

With conventional substrates, such as polyester, which has an elastic modulus of 500×10³ psi and ultimate elongation of 100% (not shown) as an electrical signal is applied to the conductor trace pattern, forces on the conductors result in a curved or parabolic displacement of the diaphragm material between clamped edges of the rigid diaphragm frames. Acoustic output of the speaker is maximum when the center of the curved diaphragm hits the stator frames on either side of the diaphragm. As the stiffness of the diaphragm material is reduced, the conductors are no longer constrained by the motion of the substrate. At very low frequencies, by adjusting the the compliance across the surface, motion of the diaphragm approaches that of a piston resulting in greater acoustic output for a given sized transducer.

The diaphragms of the present invention exhibit lower distortion and smoother frequency response than conventional planar magnet transducers. As a diaphragm undergoes displacement, bending of the diaphragm material back and forth can set up longitudinal waves that travel along the surface of the diaphragm 10 and reflect off of the diaphragm frame boundary.

The diaphragm substrate material 20, its compliance and the compliance of the conductor traces 30 have a significant influence on distortion that results from waveforms which set up on the surface of the diaphragm 10. Both harmonic and time distortions can be measured as a result of this property of a flat loudspeaker diaphragm. In a planar magnetic transducer, transverse waves on the diaphragm are undesirable, often resulting in notches in frequency response due to phase cancellation. The high compliance substrate 20 results in a reduction in amplitude of surface wave nodes (not shown) and hence lower distortion, due to both the mechanical decoupling of the conductor traces 30 from the substrate 20 and internal damping by the substrate 20. An additional function of the invention is that the compliant substrate reduces the velocity of the surface waves so that phase cancellation from the reflected waves is shifted to lower frequencies below the useful operating frequency response, hence smoothing the frequency response of the diaphragm in the operating range of the transducer.

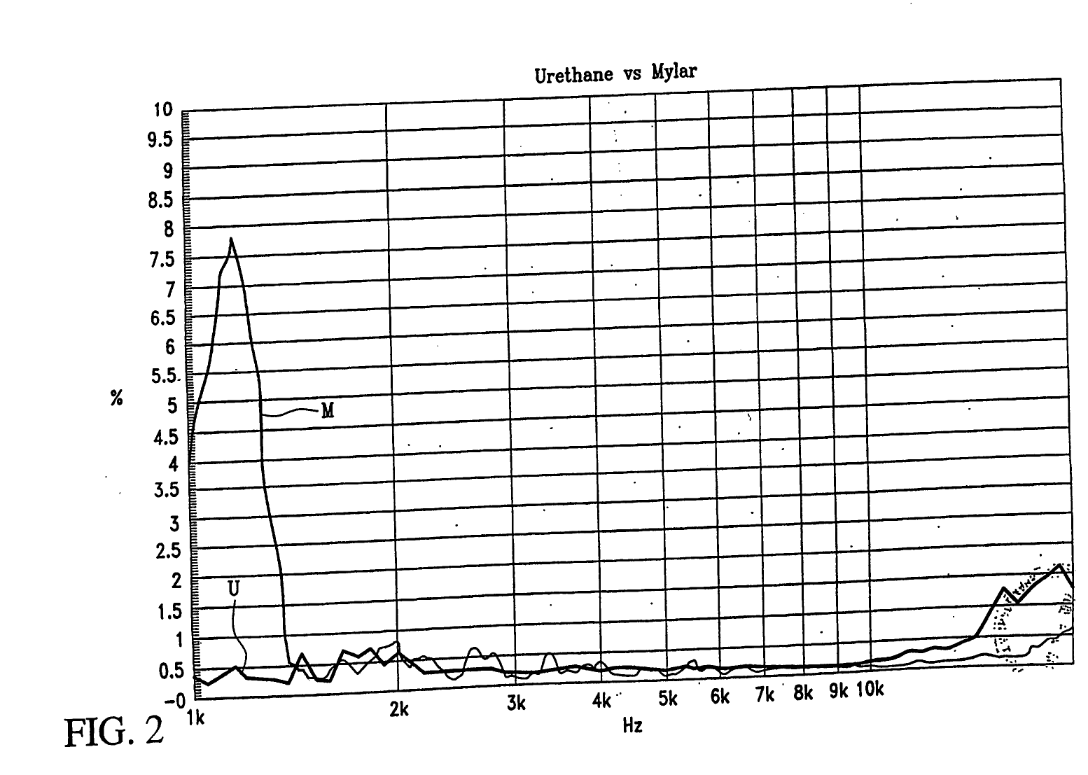

FIG. 2 shows a plot of distortion curve for two diaphragms mounted in comparable transducers but with different diaphragm substrates, Mylar® “M” versus urethane “U” (high compliance). A dramatic reduction in distortion is noticed near 1 kHz using the high compliance diaphragm substrate “U”. Test results show that where the diaphragm substrate compliance is greater than the compliance of the metallic material or foil 30 adhered to the substrate material, and preferably when the ultimate elongation of the film substrate is greater than approximately 40 times that of the metallic material, distortion is greatly reduced. That is, the ratio of the ultimate elongation “A” of the diaphragm substrate film material over the ultimate elongation “B” of the metallic trace material, should be generally greater than 40 (A÷B≧40). As previously noted, the compliance factor or value is directly related to a material's elastic modulus, mechanical stretchability and ultimate elongation.

Another embodiment of the invention is shown in FIG. 3. In this embodiment, the transducer shown is a single-sided planar magnetic transducer or speaker 80 having driving magnets 50′ provided along only one side of the diaphragms. The high compliance diaphragm 10′ is placed in the planar magnetic transducer and is tensioned so as to be located above the one magnet motor structure 35′ that includes the magnets 50′ mounted on support frame 60′ opposite support frame 62′. A substrate film 20′ having a high compliance is shown and is terminated at the frame edges as is standard in the industry. Examples of suitable materials include Urethane and Teflon® polymer thin films, however, to one skilled in the art, non-polymer compliant thin films can also be used such as Nylon® or Lycra® provided a suitable air seal is maintained. A metallic electrical conductor trace 30′ is adhesively secured to the substrate film in a conventional manner. Ultimate elongation of typically used materials such as Mylar®, Kapton®, or Kaledex® reduces the ability to have large diaphragm excursions because of limited ultimate elongation and compliance. Below resonance, the force required to stretch the material is greater than the force to move the air or available from the magnetic motor circuit thereby reducing output. Additionally, it is desirable for low frequency performance to have compliance in both axes in the plane of the diaphragm 10′. This is achieved through the substrate 20′ having a significantly higher compliance than the conductorterial 30′.

The foregoing description of the preferred embodiments of the invention has been presented to illustrate the principles of the invention and not to limit the invention to the particular embodiments illustrated. It is intended that the scope of the invention be defined by all embodiments encompassed within the following claims and their equivalents.

I claim:

1. In planar magnetic transducer including a composite diaphragm formed of a thin film having a metallic material electrical circuit trace pattern on a surface thereof and wherein the diaphragm is mounted within a stator frame such that an active area of the diaphragm having the circuit trace pattern thereon is opposed by at least one magnetic motor driver, the improvement comprising, the film having a high ultimate elongation such that a ratio of ultimate elongation “A” of the film divided by ultimate elongation of the metallic material of the electrical circuit trace pattern is generally greater than approximately 40.

2. The planar magnetic transducer of claim 1 wherein at least one magnetic motor driver is provided on each of opposing sides of the diaphragm within the stator frame.

3. The planar magnetic transducer of claim 1 wherein the film is selected from a group of materials consisting of urethane, Tefzel®, Teflon®, Nylon® and Lycra® materials.

4. The planar magnetic transducer of claim 1 wherein a configuration of the electrical circuit trace pattern and the ultimate elongation “A” of the film causes the composite diaphragm to move in a piston-like manner within the stator frame when electrical power is supplied to the electrical circuit trace pattern to thereby increase acoustic output.

5. The planar magnet transducer of claim 1 wherein the position of the electrical circuit trace pattern and the ultimate elongation “A” of the film is such as to maintain the electrical circuit trace pattern in alignment with a magnetic field created by the at least on magnetic motor driver to thereby increase acoustic output.

6. The planar magnetic transducer of claim 1 wherein an ultimate elongation of the composite diaphragm within the frame is non-uniform across its surface to thereby cause the composite diaphragm to move in a piston-like manner within the stator frame when electrical power is supplied to the electrical circuit trace pattern and thus increases acoustic output.

7. An acoustic speaker incorporating the planar magnetic transducer of claim 1.

8. A method of improving low frequency performance of a planar magnetic transducer including providing a frame defining a central open area and mounting within the frame a composite diaphragm formed of a thin film having a metallic material electrical circuit trace pattern applied thereon and wherein the film has an ultimate elongation which is substantially greater than an ultimate elongation of the metallic material and wherein the circuit pattern is applied to the film in such a manner that the composite diaphragm moves with a piston-like motion within the frame when electrical power is supplied to the circuit pattern.

9. The method of claim 8 wherein the ultimate elongation of the film is selected to be at least approximately forty times that of the ultimate elongation of the metallic material.

10. A planar magnetic transducer having improved low frequency performance, the transducer including a frame in which a composite diaphragm is mounted so as to establish an active area within the frame and wherein the composite diaphragm includes a thin film having a metallic material electrical circuit trace pattern on a surface thereof, at least one magnetic motor driver mounted with the frame for creating a magnetic field, and wherein an ultimate elongation of the active area of the composite diaphragm within the frame is non-uniform across its surface to thereby cause the active area of the composite diaphragm to move in a piston-like manner within the frame when electrical power is supplied to the electrical circuit trace pattern.
